(19) United States
(12) Patent Application Publication
(10) Pub. No.: US 2026/0326395 A1
(43) Pub. Date: Oct. 22, 2026

(54) Three-Dimensional Composite Pultrusion Process

(71) Applicant: Pulflex Technologies LLC, Ford City, PA (US)

(72) Inventors: Steven Mansfield, Beaver Falls, PA (US); Craig Lawson, Slippery Rock, PA (US)

(73) Assignee: Pulflex Technologies LLC, Ford City, PA (US)

(21) Appl. No.: 19/724,834

(22) Filed: Jun. 29, 2026

Related U.S. Application Data
(63) Continuation of application No. 17/835,904, filed on Jun. 8, 2022, now abandoned.
(60) Provisional application No. 63/548,431, filed on Nov. 14, 2023.

(51) Int. Cl. B29C 70/52; B29C 70/54

(52) U.S. Cl. CPC B29C 70/523; B29C 70/527; B29C 70/528; B29C 70/545

(57) ABSTRACT

A pulforming system for forming a three-dimensional article includes a plurality of fibers, a resin injection system, resin, a preform die, a movable first pulling sled, a movable second pulling sled and a cutting station. The first and second pulling sleds form the fibers and resin into an article using a sequential, continual movement process of back-and-forth translational motion in unison to form an article that is three-dimensional in one or more of a longitudinal or transverse direction.

### CROSS-REFERENCE TO RELATED APPLICATION

This application claims priority to U.S. Provisional Patent Application No. 63/197,996, filed Jun. 8, 2021 and U.S. patent application Ser. No. 17/835,904, filed on Jun. 8, 2022, the disclosures of which are incorporated herein by reference in their entirety.

### FIELD

The invention concerns a pulforming process for forming shaped pultrusion products.

### BACKGROUND

As the overall need for energy efficiency grows, it is incumbent upon industry to quickly expand and adapt the weight of materials, consequently reducing dependance upon fossil fuels and carbon footprints. Thermoset composite material matrixes provide great adaptability for strength to weight ratios in achieving light-weight materials of this nature.

Pultrusion is a continuous process for the manufacture of fiber-reinforced plastics with constant cross-section. The term is a combination of “pull” and “extrusion.” As opposed to extrusion, which pushes the material, pultrusion pulls the material. In the standard pultrusion process, reinforcement materials like fibers are impregnated with resin and pulled through a heated stationary die where the resin undergoes polymerization. Pultrusion uses continuous lengths of fiberglass reinforced polymers with a constant cross-section are produced. During this process, reinforced fibers, liquid pultrusion resins, pigments, and other raw materials are normally pulled through a heated die, which converts them into fiberglass reinforced panels (“FRP”) composite products.

The pultrusion process starts with the support of the reinforcing filaments. These can be glass, carbon, or aramid in a roving/tow, mat, woven, or stitched format. The fibers are pulled into an infeed area where they are impregnated with a resin matrix. The fibers are impregnated with resin either by pulling the reinforcement through a bath or by injecting the resin into an injection chamber that is connected to the die. Many resin types may be used in pultrusion, such as polyester, polyurethane, vinyl ester, epoxy, phenolic, thermoplastics (e.g., polybutylene terephthalate (PBT), polyethylene terephthalate (PET)), and other materials.

From the infeed area, the impregnated materials are pulled into a heated pultrusion die. The resin matrix solidifies and cures within the die. The cured material that exits the die is in a set form that is typically unable to be further transformed in shape. The cured material is clamped and pulled by a reciprocating puller unit that that reciprocates in a hand over hand motion. The return stroke is faster than the pulling stroke to give a smooth continuous pull at a constant speed. Then the cured material passes into a cutting unit where it is sawed off and cut into desired lengths.

Existing pultrusion processes have limitations in that they limit the shape of pultruded products in two dimensions longitudinally. In particular, thermoset materials upon cure are unable to be further transformed into three dimensional shapes in either the longitudinal or transverse direction or varying planes in the continual process. The time from which fibers are quenched with resin, and geometry is finalized, e.g., the open time, varies greatly in pultrusion as it exists. This limitation to two-dimensions creates esthetic design and physical application barriers, which limits the advantages of pultruded thermoset composites.

Pulforming is a variation of simple pultrusion that allows for some cross-sectional variation. Pulforming pulls material through the mold for impregnation and then presses the materials into a mold to cure. It is a semicontinuous process where pulled out impregnated reinforcement is placed into a two-part heated mold where the final shape is reached and the composite it cured. In pulforming, the die is no longer stationary but is moving back and forth along the profile to be manufactured. Pulforming is typically used to make semi-circular parts using a shaping die and a shoe die. The shaping die takes a circular cross-sectioned part and shapes it in the shaping die. The part then enters the shoe die where it takes on a semi-circular shape other than a straight rod. The part is forced through the shoe die to take the semi-circular shape of the die. One type of product manufactured with this process is a leaf spring. Pulforming is pultrusion with the added operation of a shape change in the length (straight length becomes curved) and cross-section (different cross-sections throughout the length). Pulformed products do not have a constant cross-sectional shape but do have a constant cross-sectional area at any point along the length of the profile.

While current technology permits either straight or non-variable radius pultruded materials, a process does not exist to produce materials with sequential continuous varied geometries or radii along multiple planes.

### BRIEF DESCRIPTION OF THE DRAWINGS

FIG. 1 depicts the inventive pultrusion process according to the invention; and

FIG. 2 depicts an enlarged view of the process depicted in FIG. 1.

### SUMMARY

A process for pulforming is disclosed herein for forming an article in three-dimensions using pultrusion, such as an article having a change of plane in a single part.

### DETAILED DESCRIPTION

The improved pulforming process described herein allows for three-dimensional, multiplanar, continuous fiber, variable geometry combinations, in what was previously a process limited in two dimensions. This application will provide options in physical design and esthetics previously unavailable.

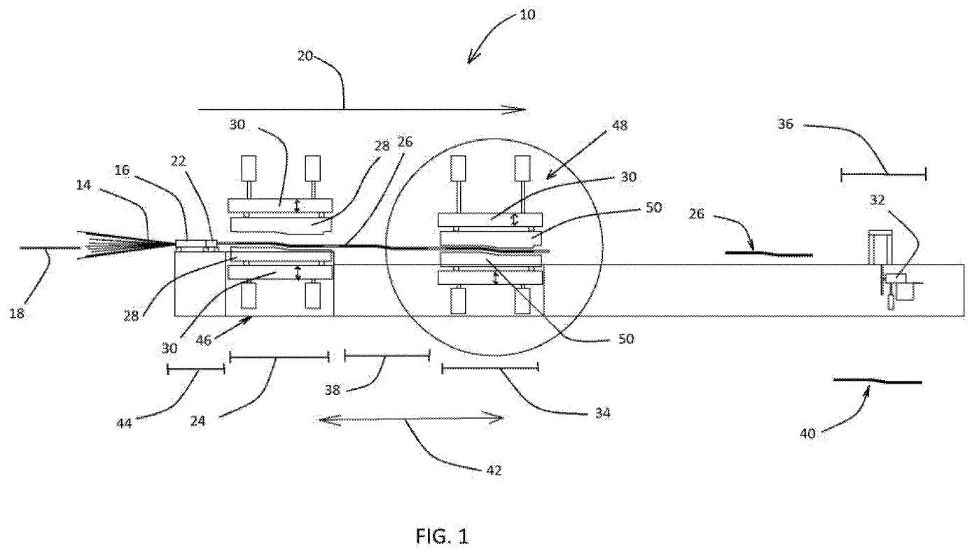

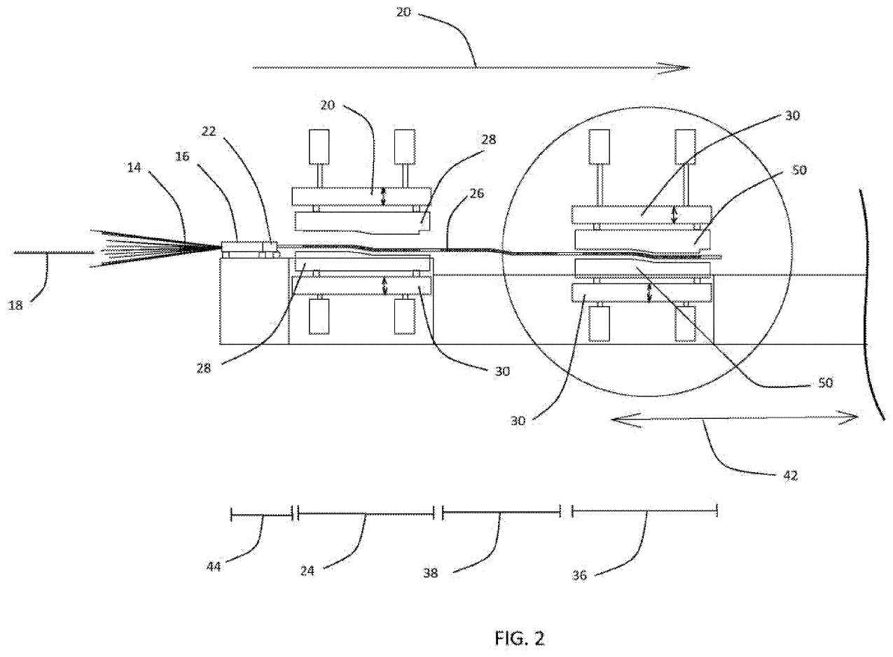

FIGS. 1 and 2 depict the pultrusion process 10 according to the invention. According to the process described herein, a pultruded material can be transformed into three-dimensional shapes in either the longitudinal or transverse direction, or varying planes in a continual process. The present process permits for the production of materials with sequential continuous varied geometries along multiple planes. The process also permits the production of materials with sequential continuous varied radii along multiple planes. As shown in the figures, for example, the process is capable of making a part that has a first plane and a second plane connected by a bend.

FIG. 1 depicts the entire forming process while FIG. 2 depicts the same process 10 but does not show the cutting process 12. As shown in the figures, the direction of process flow occurs from left to right as indicated by arrow 20.

The system includes a resin injection station 44, which is typically stationary, a first pull sled station 24, a second pull sled station 34, both of which move, and a cutting station 36, which is typically stationary. An intermediate section 38 is positioned between the first and second pull sled stations 24, 34. The pull sled stations 24, 34, work simultaneously in unison to move the material 26 through the system 10 and move back and forth, left to right, as indicated by arrow 42. As the pull sleds 24, 34 move the material 26 through the system 10, some of the material 26 will be present in the intermediate section 38 between the time it is operated on in the first pull sled station 24 and moved in the second pull sled station 34. The first pull sled station includes a first pull sled 46 and the second pull sled station has a second pull sled 48.

As shown in FIGS. 1 and 2, fiber 14 is fed into a resin injection system 16 with or without a core 18. One type of core 18 that could be used is a foam insert. The fiber 14 may be a glass fiber or fabric, or other known materials used in pultrusion processes. Resin is injected into the resin injection system 16 and the raw fibers 14 are impregnated with resin. Impregnated fibers are then pulled through a preform die 22 by a first pull sled 24.

The first pull sled 24 has a forming tool 28 that has an open and a closed position, with the open position being shown in FIGS. 1 and 2. The forming tool 28 has a space positioned between a top and bottom part thereof. The closed position, while not shown, can be easily deduced from the image and would show the top and bottom parts of the forming tool 28 being positioned against one another with the material 26 trapped therebetween. Parts 30 move up and down to close the forming tool 28 top and bottom parts and the entire first pull sled station moves horizontally from left to right and then back to left, continuously while the forming tool 28 opens and closes to form the material 26. The forming tool 28 includes a heating and a cooling function. The forming tool 28 clamps down on the material 26 where it is heated (e.g., cured) and cooled while being held between the top and bottom plates. When held between the top and bottom plates, the material 26 is formed into a desired shape. In addition to forming the material 26 into a desired shape, the first pull sled 24 pulls the material 26 through the system 10 in concert with a second pull sled 34.

The first pull sled 24 has a stroke that has a length and a period of time. The material 26 is held by the first pull sled 24 during substantially the entire stroke of the pull sled. Alternatively, the material could be released prior to the entire stroke of the pull sled 24. The second pull sled 34 has the same stroke as the first pull sled 24.

The second pull sled 34 works in concert with the first pull sled 24 to move the material 26 through the system 10. After the material 26 is released from the first pull sled 24, the second pull sled engages the material 26 by clamping down on it with pads 50. The second pull sled 34 has pads 50 that geometrically match the shape of the material 26 that was formed in the first pull sled 24. The pads 50 of the second pull sled 34 comprise either a metal or rubber/silicone so as to not distort or damage the shape of the material 36 formed in the first puller 24. Because the material is already formed before it enters the second pull sled station 34, the second pull sled station 34 is used to assist in moving the material 26 through the system between the first pull sled station 24 and out of the cutting station 36. Before the material 26 enters the second sled station 34, an intermediate section of the material 26 is positioned between the first and second pull sled stations 24, 34. In the example described herein, the second pull station 34 does not include a forming tool 28 but could also include a forming tool if desired to further process the shape of the material 26.

As discussed above, the process also includes a heating and cooling forming tool 28 that is used to shape the material 26. The heating and cooling forming tool 28 performs heating and cooling of the material 26 that exits the preform die 22. The forming tool 28 closes upon the material 26 that exits the preform die 22 and hot oil (not shown) is pumped through the forming tool 28 to cure the material 26. Then a water line (not shown) is used to cool the material 26 in the forming tool 28. This occurs while the material is moving via the first pull sled 24. Once the material 26 has been cured and cooled, the forming tool 28 releases the material 26 and the second pull sled 34, which is positioned downstream of the forming tool 28, pulls the material 26 from the forming tool 28 such that a new section of material 26 can enter the forming tool 28. This process repeats to permit each formed section of the material 26 to move forward in the process 10 after it has been cured and cooled. The formed material 26 reaches almost a full cure, e.g., about 95 to about 98 percent, or enough to maintain its shape during the stroke.

The pull sleds 24, 34 both move simultaneously and in unison to repeat the process 10. The cycle of movement of the pull sleds 24, 34 is sequentially timed and repetitive for the duration of the manufacturing process. The first and second pull sleds 24, 34 do not overlap, which is why there will always be an intermediate section 38 of material 26 between the first and second pull sleds 24, 34. This is also why the stages must be timed together in unison. In typical pultrusion or extrusion, which is only two dimensional, it is important to have the first and second stage timed together fairly closely. However, in the present process, the first and second sleds 24, 34 are timed to operate in unison. Otherwise, if they are not operating in unison, the second pull sled 34 could clamp down inappropriately on one of the formed areas of the material 26 and crush or distort it.

After the second sled station 34 releases the formed material 26, the formed material 26 advances to the cutting assembly 36, where it is cut by the saw 32 into a prescribed length representing the finished product 40.

The process involves taking a material having a two-dimensional geometry that is uncured and pulling it into the mold that is formed by the forming tool 28 using a first and second pulling sled 24, 34. The forming tool 28 closes on the material 26 and reshapes it into a new geometric shape that a customer requires.

While foam is presently used as an insert, e.g., core 18, in pultrusion, the foam utilized in the present process is advantageous in that it helps the material hold its shape when the pulling sleds 24, 34 and forming tool 28 closes on the material 26. The foam may be a thermoplastic foam, or other known materials used in the pultrusion process.

The preform die 22 may or may not be heated. Typically, the forming tool 28 would be heated to 280 degrees F to 400 degrees F depending upon the resin system and catalyst used.

Software, a computer, and a controller, among other computer-based products, can be used to control the pull sleds 24, 34/forming tool 28, as known by those of skill in the art. Curing time within the system 10 is a function of the thickness of the part 40 and thicker parts would normally take longer to cure. In addition, the resin system and catalyst utilized also have an impact on total cure time. Depending on the thickness of the part 40, this can take anywhere from approximately 1 minute to 10-12 minutes per cycle.

The pulling sleds 24, 34 may use servo motors to control the movement of the sled 24. Alternatively, hydraulics could be used. The second pull sled 34 may include cast urethane pads to match the finished part that exits the forming tool. The pull sled 24 is positioned at a height and spacing based upon the part being formed. While the pulling sled 24 is shown being a separate device from the forming tool 28, in an alternative embodiment, the functions of the forming tool 28 and of the pulling sled 24 could be performed by a single device.

The fibers may be made of any number of different materials. Possible materials include glass or fabrics. Resin types may include polyester, polyurethane, vinyl ester, epoxy, phenolic, thermoplastics (e.g., polybutylene terephthalate (PBT), polyethylene terephthalate (PET)), and other materials.

In a first embodiment, a pulforming system for forming a three-dimensional article includes a first material comprising a plurality of fibers and an optional core, a resin injection system, a preform die, a movable first pulling sled, a movable second pulling shed, and a cutting station. The resin injection system is for injecting resin into the first material to impregnate the resin into the first material. The preform die is for forming the first material into an initial shaped material. The movable first pulling sled is coupled to a forming tool that closes on the initial shaped material to move the initial shaped material and form the initial shaped material into a formed material. The movable second pulling sled has a clamping tool for clamping down and moving the formed material. The cutting station has a cutting mechanism for cutting the formed material into a final product. The first and second movable pulling sleds engage the initial shaped material and the subsequent formed material in a sequential, continual movement process of back-and-forth translational motion in unison to form an article that is three-dimensional in one or more of a longitudinal or transverse direction.

The article may have varying planes, geometries, or radii along multiple planes. The plurality of fibers may comprise glass or fabrics. The resin may comprise polyester, polyurethane, vinyl ester, epoxy, phenolic, or thermoplastics. The core may comprise a foam insert. The forming tool may heat the initial shaped material to cure it and cool the formed material after it has cured. The forming tool is heated to between about 280 °F and about 400 °F.

The clamping tool of the second pull sled may be pads shaped to match the shape of the finished part that exits the forming tool. The pads may be cast urethane pads. The first and second pull sleds are positioned at heights and a spacing that is based upon the article being formed. The system may cure the formed material at least partially.

An intermediate section may be positioned between the first pulling sled and the second pulling sled and a formed material may be positioned between the first and second pulling sleds. The forming tool may comprise a top part and a bottom part that are movable relative to one another that together define a shape for the formed material. The pads may geometrically match the shape of the formed material. The first and second pulling sleds may move simultaneously in unison.

In another embodiment a pulforming process may include inserting a plurality of fibers into a resin injection system, injecting resin into the plurality of fibers to impregnate the resin into the plurality of fibers and pulling the impregnated fibers through a preform die to form the impregnated fibers into an initial shaped material. After forming an initial shape, the process engages the initial shaped material with a forming tool that is coupled to a first pulling sled that is continuously moving in a back-and-forth motion. Then the forming tool closes upon the initial shaped material to heat and cool the initial shaped material to at least partially cure the initial shaped material into a formed material. Then the forming tool is opened to release the formed material from the forming tool and the first pulling sled is retracted to engage with another initial shaped material. The formed material is engaged with a clamping tool that is coupled to a second pulling sled that is continuously moving in a back-and-forth motion to move the formed material in a forward direction. The formed material is then released from the clamping tool when the second pulling sled is in a forward position and the formed material is introduced to a cutting station having a cutting mechanism. The formed material is then cut with the cutting mechanism into an article. The first and second pulling sleds engage the initial shaped material and the subsequent formed material in a sequential, continual movement process of back-and-forth motion in unison to form a final product that is three-dimensional in one or more of a longitudinal or transverse direction

The final product may have varying planes, geometries, or radii along multiple planes. The heating may be performed by the forming tool and occurs at a temperature between about 280 °F and about 400 °F. A core may be inserted in the plurality of fibers prior to injecting resin.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. All percentages and averages are by weight unless the context indicates otherwise. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

1. A pulforming system for forming a three-dimensional article comprising:
a first material comprising a plurality of fibers and an optional core;
a resin injection system for injecting resin into the first material to impregnate the resin into the first material;
a preform die for forming the first material into an initial shaped material;
a movable first pulling sled coupled to a forming tool that closes on the initial shaped material to move the initial shaped material and form the initial shaped material by heating and at least partially cooling the initial shaped material into a formed material having a length L;
a movable second pulling sled having a clamping tool for clamping down and moving the formed material; and
a cutting station having a cutting mechanism for cutting the formed material into a final product,
wherein the system has a structure and is driven such that the first and second movable pulling sleds engage the initial shaped material and the subsequent formed material in a sequential, continual movement process of back-and-forth translational motion in unison without the first and second pulling sleds or the formed material stopping to form an article that is three-dimensional in one or more of a longitudinal or transverse direction.

2. The pulforming system of claim 1, wherein the article has varying planes, geometries, or radii along multiple planes.

3. The pulforming system of claim 1, wherein the plurality of fibers comprises glass or fabrics.

4. The pulforming system of claim 1, wherein the resin comprises polyester, polyurethane, vinyl ester, epoxy, phenolic, or thermoplastics.

5. The pulforming system of claim 1, wherein the core comprises a foam insert.

6. The pulforming system of claim 1, wherein the forming tool heats the initial shaped material to cure it and cools the formed material after it has cured.

7. The pulforming system of claim 1, wherein the forming tool is heated to between about 280 °F and about 400 °F.

8. The pulforming system of claim 1, wherein the clamping tool of the second pull sled is pads shaped to match the shape of the finished part that exits the forming tool.

9. The pulforming system of claim 8, wherein the pads are cast urethane pads.

10. The pulforming system of claim 1, wherein the first and second pull sleds are positioned at heights and a spacing that is based upon the article being formed.

11. The pulforming system of claim 1, wherein the system cures the formed material at least partially.

12. The pulforming system of claim 1, wherein an intermediate section is positioned between the first pulling sled and the second pulling sled and the length L of the formed material is positioned between the first and second pulling sleds in the intermediate section.

13. The pulforming system of claim 1, wherein the forming tool comprises a top part and a bottom part that are movable relative to one another that together define a shape for the formed material.

14. The pulforming system of claim 8, wherein the pads geometrically match the shape of the formed material.

15. The pulforming system of claim 1, wherein the first and second pulling sleds move simultaneously in unison.

16. A pulforming process utilizing the pulforming system according to claim 1, comprising:
inserting a plurality of fibers into the resin injection system;
injecting resin into the plurality of fibers to impregnate the resin into the plurality of fibers;
pulling the impregnated fibers through the preform die to form the impregnated fibers into an initial shaped material;
engaging the initial shaped material with the forming tool that is carried by the first pulling sled that is continuously moving in a back-and-forth motion;
closing the forming tool and heating and cooling the forming tool to at least partially cure the initial shaped material into a formed material;
opening the forming tool to release the formed material from the forming tool and retracting the first pulling sled to engage with another initial shaped material;
engaging the formed material with the clamping tool that is coupled to the second pulling sled that is continuously moving in a back-and-forth motion to move the formed material in a forward direction;
releasing the formed material from the clamping tool when the second pulling sled is in a forward position;
introducing the formed material to the cutting station having a cutting mechanism; and
cutting the formed material with the cutting mechanism into an article while the formed material is continually moving without stopping,
wherein the first and second pulling sleds engage the initial shaped material and the subsequent formed material in a sequential, continual movement process of back-and-forth motion in unison to form a final product that is three-dimensional in one or more of a longitudinal or transverse direction.

17. The process of claim 16, wherein the final product has varying planes, geometries, or radii along multiple planes.

18. The process of claim 16, wherein the heating performed by the forming tool occurs at a temperature between about 280 °F and about 400 °F.

19. The process of claim 16, further comprising inserting a core in the plurality of fibers prior to injecting resin.
